(19) United States
(12) Patent Application Publication
(10) Pub. No.: US 2018/0347761 A1
(43) Pub. Date: Dec. 6, 2018

(54) VALVE, STORAGE FACILITY AND FILLING STATION

(71) Applicant: L'Air Liquide, Societe Anonyme pour l'Etude et l'Exploitation des Procedes Georges Claude, Paris (FR)

(72) Inventors: Yves Lacombe, Veurey-Voroize (FR); Thierry Ott, Brunoy (FR); Adrien Zanoto, Paris (FR)

(73) Assignee: L'Air Liquide, Societe Anonyme pour l'Etude et l'Exploitation des Procedes Georges Claude, Paris (FR)

(21) Appl. No.: 15/996,008

(22) Filed: Jun. 1, 2018

(30) Foreign Application Priority Data
Jun. 1, 2017 (FR) FR 1754870

(51) Int. Cl. F17C 13/04; F17C 5/06

(52) U.S. Cl. CPC F17C 13/04; F17C 5/06; F17C 2205/0326; F17C 2250/0439; F17C 2205/0332; F17C 2221/012; F17C 2250/043; F17C 2205/0391

(57) ABSTRACT

Valve for storage of fluid under pressure, comprising a body housing a fluid circuit comprising a first end intended to be connected to the orifice of at least one pressurized fluid storage facility, at least one second, draw-off end, at least one third, filling end, the second end and the third end being connected to the first end via a draw-off branch of the circuit and a filler branch of the circuit, respectively, the draw-off branch and the filler branch being connected in parallel to the first end of the circuit and each comprising a set of valves,

characterized in that the circuit includes two distinct draw-off ends fluidically connected to the draw-off branch and leading to the body of the valve at the level of two respective distinct orifices.

### CROSS-REFERENCE TO RELATED APPLICATIONS

This application claims the benefit of priority under 35 U.S.C. § 119 (a) and (b) to French patent application No. FR 1754870, filed Jun. 1, 2017, the entire contents of which are incorporated herein by reference.

### BACKGROUND

### Field of the Invention

The invention concerns a valve, a pressurized gas storage facility and a corresponding filling station.

The invention more particularly concerns a valve for a storage facility for fluid under pressure, in particular hydrogen gas, comprising a body housing a fluid circuit comprising a first end intended to be connected to the orifice of at least one pressurized fluid storage facility, at least one second, draw-off end intended to be connected to a receiver circuit to enable the supply of fluid drawn off from the storage facility via the circuit, at least one third, filling end intended to be connected to a source of gas under pressure to enable the filling of the storage facility via the circuit, the second end and the third end being connected to the first end via a draw-off branch of the circuit and a filler branch of the circuit, respectively, the draw-off branch and the filler branch being connected in parallel to the first end of the circuit and each comprising a set of valves.

The invention concerns in particular a high-pressure valve, notably for hydrogen applications (tank(s) and mobile or fixed stations).

### Related Art

Numerous valves and corresponding stations have been proposed for these applications. However, these known solutions do not enable optimization of filling and dispensing performance combined with modular usage.

In particular, the known solutions do not enable simultaneous guarantees of a high level of modularity of the storage facilities used in filling stations (used in particular for pressure balancing and/or as a compressor source).

### SUMMARY OF THE INVENTION

An object of the present invention is to overcome all or some of the disadvantages of the above prior art.

To this end, the valve according to the invention, otherwise conforming to the generic definition thereof given in the above preamble, is essentially characterized in that the circuit includes two distinct draw-off ends fluidically connected to the draw-off branch and leading to the body of the valve at the level of two respective distinct orifices.

Moreover, embodiments of the invention can include one or more of the following features:
the two distinct draw-off ends communicate fluidically with one another and with the filler branch,
the circuit includes two distinct filler ends fluidically connected to the filler branch and leading to the body of the valve at the level of two respective distinct orifices,
the two distinct filling ends communicate fluidically with one another and with the filler branch,
the draw-off ends and/or the filler ends lead to the body at the level of respective fluidic connections mounted on the body,
the draw-off branch and the filler branch each comprise a respective valve, in particular a motorized valve, in series with a respective unidirectional valve, in particular a check valve,
the circuit includes a first isolation valve situated between on the one hand the two draw-off and filler branches and on the other hand the first end of the circuit,
the circuit includes at least one safety draining member configured to free a gas evacuation passage between the first end of the circuit and at least one evacuation orifice leading to the body if the draining member is subjected to a temperature and/or a pressure above a particular threshold,
the circuit comprises a purge line having an upstream end connected in the portion situated between the first isolation valve and the two draw-off and filler branches and a downstream end connected to the evacuation orifice or orifices of the draining member, the purge line comprising a second isolation valve,
the circuit includes a pressure sensor and/or a temperature sensor,
the station comprises a plurality of pressurized gas storage facilities of this type connected to the transfer line, at least some of the storage facilities being connected in parallel to the transfer line via their draw-off ends,
the circuit of the valve includes a pressure sensor situated between the first isolation valve and the first end of the circuit and/or between the first isolation valve and the second isolation valve,
the circuit of the valve includes at least one pressure sensor situated between the first isolation valve and the first end of the circuit,

The invention also concerns a pressurized gas storage facility or pressurized gas storage facilities comprising an orifice connected to a valve according to any one of the following or above features.

The invention also concerns a station for filling pressurized gas tanks comprising at least one pressurized gas storage facility connected to at least one transfer line intended to be connected to a pressurized gas tank to be filled to provide a transfer of gas from the storage facility to the tank, the transfer line being connected to one of the draw-off ends of the body of the valve of the storage facility.

According to other possible features
one of the filler ends of the body of the valve of the storage facility is connected to a source of gas under pressure comprising a compressor and/or a gas and/or liquid tank,
at least some of the storage facilities are connected in parallel to the pressurized gas source via their filler ends,
each valve includes two evacuation orifices leading to the body for evacuating the gas freed by the draining member, the storage facilities being connected in parallel to a gas evacuation line via their evacuation orifices,
the at least one storage facility contains gas at a pressure between 50 and 1100 bar inclusive,
the station comprises a set of pressurized gas storage facilities connected in parallel to the transfer line, to the source of gas under pressure and to the evacuation line, in which, a first gas storage facility has a draw-off end directly connected to the transfer line whereas the other draw-off end is connected to a draw-off end of the adjacent storage facility, the first storage facility has a filler end directly connected to the source of gas under pressure whereas the other filler end is connected to a filler end of the adjacent storage facility, the subsequent gas storage facilities having their two draw-off ends respectively connected to the draw-off ends of the two adjacent storage facilities, and their two filler ends respectively connected to the filler ends of the two adjacent storage facilities, the last gas storage facility of the set having a draw-off end connected to the draw-off end of the penultimate adjacent storage facility and the other draw-off end blocked by a plug, the last gas storage facility the set having a filler end connected to the filler end of the penultimate adjacent storage facility and the other filler end blocked by a plug.

The invention can also concern any alternative device or method comprising any combination of the above or following features.

### BRIEF DESCRIPTION OF THE FIGURES

Other features and advantages will become apparent on reading the following description given with reference to the figures in which:

FIG. 1 is a diagrammatic partial view illustrating an example of a storage facility comprising a valve according to a first embodiment of the invention,

FIG. 2 is a diagrammatic partial view showing an example of a filling station comprising a set of storage facilities according to the invention,

FIG. 3 is a diagrammatic partial view showing another example of a filling station comprising a set of storage facilities according to the invention.

### DETAILED DESCRIPTION OF THE INVENTION

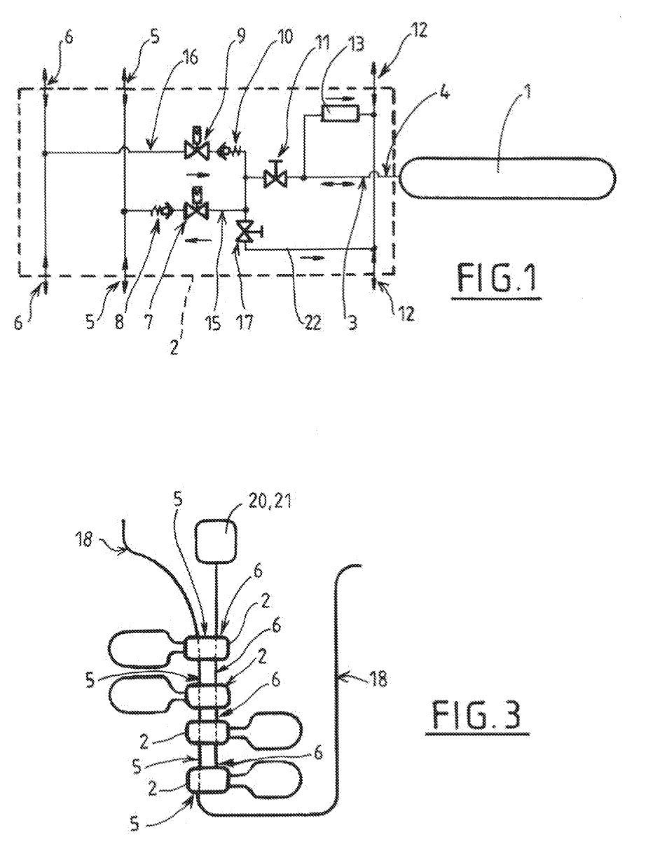

The valve shown in FIG. 1 is connected to the (preferably single) orifice of a pressurized fluid storage facility, notably a pressurized hydrogen gas storage facility, for example at a pressure up to 1100 bar (metal or composite storage facility structure for example).

The valve comprises a body 2 housing a fluid circuit 3 comprising a first end 4 connected to the orifice of the storage facility 1. For example, the first end 4 of the valve leads to the level of an externally threaded portion intended to be threaded into the internally threaded orifice of the storage facility 1. Alternatively, this first end could of course be connected to a set of distinct storage facilities (a rack of cylinders for example). In other words the valve would be common to a plurality of storage facilities and connected to the latter by circuitry.

The fluid circuit 3 of the valve comprises two draw-off ends 5 intended to be connected to a receiver circuit to enable the supply of fluid drawn off from the storage facility 1. These two distinct draw-off ends 5 lead to the body 2 of the valve via respective orifices.

The two distinct draw-off ends 5 lead to the body 2 of the valve and are fluidically connected to the draw-off branch 15, i.e. the two distinct draw-off ends 5 can communicate fluidically with one another and with the draw-off branch 15.

The two draw-off ends 5 are situated downstream of the set of valves of the draw-off branch 15. The two ends are connected in parallel to the rest of the draw-off branch 15. In other words, downstream of the valves of the draw-off branch 15 the downstream end of the draw-off branch 5 is divided in two, leading to these two ends (or outlets) 5 on the body of the valve. Moreover, the gas can pass from one draw-off end 5 to the other without passing through the set of valves of the draw-off branch 15. In other words, the gas drawn off via one or the other of the draw-off ends 5 has passed through the same valves of the draw-off branch 15. The word “downstream” is relative to the direction of flow of the gas in the draw-off branch 15 from upstream (the storage facility) to downstream (one or the other of the ends 5).

Each of these draw-off ends 5 leads to the body 2 for example at the level of a standard or non-standard fluidic connector.

The circuit 3 also comprises two filler ends 6 intended to be connected to a source of gas under pressure to enable filling of the storage facility 1. As before, these two filler ends 6 can lead to the body 2 (for example at the level of respective standard or non-standard fluidic connectors).

The two distinct filler ends 6 lead to the body 2 of the valve and are connected fluidically to the filler branch 16. In other words, the two distinct filler ends 6 can communicate fluidically with one another and with the filler branch 16.

The second (draw-off) end 5 and the third (filler) end 6 are therefore distinct and connected to the first end 4 via respective branches of the circuit 3: respectively a draw-off branch 15 and a filler branch 16. In other words, for filling and for drawing off from the storage facility 1, the fluid passes through distinct orifices of the valve (two inlets and two outlets that are independent) before taking a common circuit portion (the two branches 15, 16 joining before or at the level of the first end 4 of the circuit 3).

In other words, the draw-off branch 15 and the filler branch 16 are connected in parallel at the first end 4. The draw-off branch 15 and the filler branch 16 each comprise a set of valves. To be more precise, the draw-off branch 15 and the filler branch 16 each comprise a respective valve 7, 9 in series with a respective unidirectional valve 8, 10.

Each valve 7, 9 is for example a motorized valve, in particular a pneumatic valve. Of course any other type of valve can be envisaged (manual valve, solenoid valve, hydraulic valve, . . . ).

Each respective unidirectional valve 8, 10 is for example a check valve (mobile closure member associated with a return member that can be opened by a pressure differential in only one direction (the filler direction or the draw-off direction, respectively)).

As described in detail hereinafter, this architecture with double inlets 6 and double outlets 5 enables integration of a storage facility 1 of this kind into a circuit of a filling station with a guaranteed good seal in the case of bidirectional use (filling of/drawing off from the storage facility 1). In particular, this architecture enables simplification of the connections and the sizing of the station.

This also enables decorrelation of pressurization and depressurization of the storage facility 1. This also enables simplification of the assembly and the maintenance of a storage facility 1 of this kind in a circuit into which it is integrated.

This architecture enables the valve to have a high working pressure, for example 1100 bar.

The circuit 3 of the valve preferably also includes a first isolation valve 11 situated between on the one hand the two draw-off and filler branches 15, 16 and on the other hand the first end 4 of the circuit 3. In other words, the first isolation valve 11 is situated on the portion of the circuit 3 that is common to the operations of filling/drawing off from the storage facility 1. This first isolation valve 1 can be a manual valve and/or a motorized valve.

The valve preferably also includes a safety draining member 13 configured to free a passage for evacuation of the gas from the storage facility 1 if it is subjected to a temperature and/or a pressure above a particular threshold. This optional member 13 is for example a fusible member that opens up a (normally closed) passage between the first end 4 of the circuit 3 and at least one evacuation orifice 12 leading to the body 2 (for example two evacuation orifices 12 as shown here).

The circuit 3 can also comprise a purge line 22 having an upstream end connected to the first isolation valve 11 and the two draw-off and filler branches 15, 16 and a downstream end connected to the evacuation orifice or orifices 12 of the draining member 13. This purge line 22 comprises for example a second (manual and/or motorized) isolation valve 17. Opening the second isolation valve 17 therefore enables evacuation via the evacuation orifice or orifices 12 of the pressurized gas situated between the first isolation valve 11 and the two filler/drawing off branches 15, 16. The evacuation orifice or orifices 12 can be vented to the atmosphere and/or connected to a gas recovery volume. This purge line can be used to drain the storage facility.

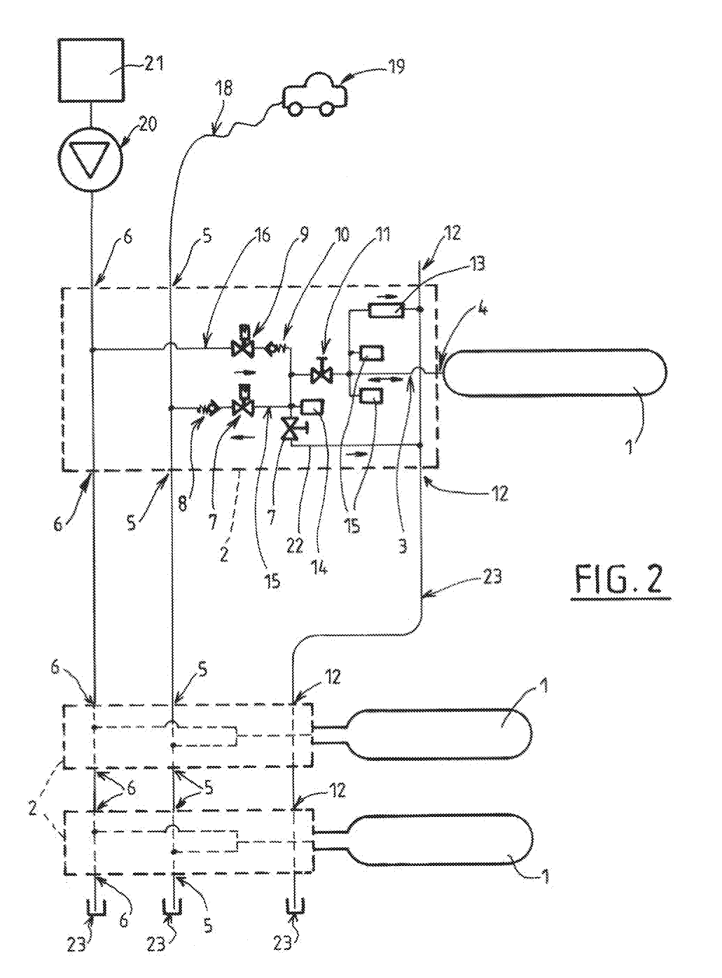

As shown in FIG. 2, the circuit 3 can also include a pressure sensor 14 and/or a temperature sensor 15. For example, the circuit 3 of the valve can include a pressure sensor 14 situated between the first isolation valve 11 and the first end 4 of the circuit 3, for example between the first isolation valve 11 and the second isolation valve 17.

Likewise, the circuit 3 of the valve can include at least one pressure sensor 15 situated between the first isolation valve 11 and the first end 4 of the circuit 3.

This valve architecture advantageously enables use of a storage facility 1 of this kind in a gas installation, in particular in a station for filling tanks, in particular hydrogen tanks. In particular (cf. FIG. 2), a third filler end 6 of the body 2 of the valve of the storage facility 1 can be connected to a source 20, 21 of gas under pressure (comprising for example a compressor 20 and/or a tank 21 of gas and/or liquid, . . . ) to enable filling of the storage facility 1 with the gas supplied by the source 20, 21.

As shown in FIG. 2, a station for filling tanks 19 can in particular use a plurality of storage facilities 1 according to FIG. 1 as buffer stores used to transfer gas into a tank 19 by balancing pressure (in particular in cascade) and/or as a gas source for a filler compressor.

The station shown in FIG. 2 comprises a plurality of storage facilities 1 (three in this example, but there could be two or more than three). The storage facilities 1 are connected in parallel to the transfer line 18 via the at least one second, draw-off end 5 of the valve of each of the storage facilities 1.

To be more precise, a first storage facility 1 (at the top in FIG. 2) includes a second, draw-off end 5 that is directly connected to the tank(s) 19 to be filled (via the line 18). The other filler end 5 of this first storage facility 1 is connected to a draw-off end 5 of the adjacent second storage facility 1. The other filler end 5 of this second storage facility 1 is connected to a draw-off end 5 of the adjacent third storage facility 1.

Of course, the draw-off ends (connectors) 5 of all the storage facilities 1 are not necessarily all connected/linked to one another and to the same draw-off line 18. This enables provision of a multiple gas dispenser with the same gas source. For example, the installation can include two (or more) groups of storage facilities respectively connected to two (or more) distinct transfer lines 18. All these storage facilities 1 can on the other hand be connected to the same source (or distinct sources) via their draw-off ends 6. In the case for example of four storage facilities 1 connected to two transfer lines 18, the draw-off ends 5 of two storage facilities 1 can be connected in parallel to a first transfer line 18 whereas the draw-off ends 5 of the other two storage facilities 1 are connected in parallel to the other transfer line 18. The four storage facilities can be connected to the same source 20, 21 via the filler ends 6. Cf. FIG. 3.

Likewise, the first storage facility 1 (at the top in FIG. 2) includes a filler end 6 connected (directly, i.e. as close as possible) to the source 20, 21 of gas under pressure whereas the other filler end 6 of this first storage facility 1 is connected to a filler end 6 of the valve of the adjacent second storage facility 1. The other filler end 6 of this second storage facility 1 is connected to a filler end 6 of the valve of the third storage facility 1.

Finally, the evacuation orifices 12 of the three storage facilities can be connected to the same purge line 23.

The ends/orifices 5, 6, 12 of the valves of the storage facilities are therefore respectively connected in parallel:
to the transfer line 18,
to the gas source 20, 21, and
to the purge line 23.

As before, not all the draw-off ends of all the tanks are necessarily linked/connected to one another but can be grouped/linked to distinct transfer lines 18.

The ends/orifices of the valve of the final storage facility 1 (the one farthest away, at the row end, at the bottom in FIG. 2) can be blocked by a system of plugs 23 for example.

Each valve associated with its storage facility 1 therefore has a double system of orifices/outlets 5, 6, 12 enabling a double connection that simplifies the interconnections between the storage facilities 1 and the rest of the station.

In this way it is relatively easy to add a storage facility 1 in parallel or to remove a storage facility at one end of this row of storage facilities 1. The costs linked to the connection of such storage facilities 1 can be minimized.

This architecture enables filling of a storage facility 1 while another is dispensing gas to a tank 22. This enables the provision of a plurality of independent dispensing terminals drawing from the same source (the compressor 20).

This architecture in particular enables parallel use of the storage facilities 1 in accordance with the cascade principle (without being limited as to the number of storage facilities 1) to optimize the quantity of gas stored in these storage facilities.

This architecture limits the number of connectors whilst enabling a high level of modularity.

This in particular enables a gradual increase in the daily capacity of the station. This also enables the number of cascade steps to be increased if necessary.

Moreover, this architecture enables use of one or more storage facilities 1 to fill one or more other storage facilities 1 of the installation (for example by balancing and where necessary from the source 20, 21).

Each storage facility 1 with its associated valve enables the replacement when necessary of a plurality of prior art storage facilities at the same time as simplifying installation and maintenance. This enables optimization of cascade filling using 60 to 70% of its capacity (instead of 30% in prior art solutions). One or more storage facilities 1 can also be used to fill one or more other storage facilities 1 (if necessary via a compressor).

If the valve of a storage facility 1 comprises a sensor or sensors for sending the pressure (and where applicable the temperature) of the gas in the circuit 3, the quantity of gas drawn off from each storage facility 1 (or with which it is filled) can be calculated using a gas state equation (PV=z.n.R.T for example).

This can replace or supplement a measurement by a mass flow meter.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications; and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A valve for a storage facility for pressurized fluid, the fluid being hydrogen gas, said valve comprising a body housing a fluid circuit that comprises:
a first end intended to be connected to an orifice of at least one pressurized fluid storage facility
at least one second end, being a draw-off end, intended to be connected to a receiver circuit to enable a supply of fluid drawn off from the storage facility via the circuit;
a draw-off branch, the second end being connected to the first end via the draw-off branch, the draw-off branch comprising first and second valves;
at least one third end, being a filling end, intended to be connected to a source of pressurized gas to enable the storage facility to be filled with the pressurized gas via the circuit;
a filler branch, the third end being connected to the first end via the filler branch, the filler branch comprising first and second valves, the draw-off branch and the filler branch being connected in parallel to the first end of the circuit; and
two distinct draw-off ends each of which is fluidically connected to the draw-off branch and leads to the body at two distinct orifices, respectively, wherein the two distinct draw-off ends are situated downstream of the first and second valves of the draw-off branch, the two distinct draw-off ends communicate fluidically with one another and with the draw-off branch.

2. The valve of claim 1, wherein the circuit includes two distinct filler ends that are fluidically connected to the filler branch and lead to the body at the two respective distinct orifices.

3. The valve of claim 2, wherein the two distinct filler ends communicate fluidically with one another and with the filler branch.

4. The valve of claim 2, wherein the draw-off ends and/or the filler ends lead to the body at respective fluidic connections mounted on the body.

5. The valve of claim 1, wherein:
the first and second valves of the draw-off branch are in series and are a motorized valve and a check valve, respectively; and
the first and second valves of the filler branch are in series and are a motorized valve and a check valve, respectively.

6. The valve of claim 1, wherein the circuit further comprises a first isolation valve situated between, on the one hand, the two draw-off and filler branches, and on the other hand, the first end of the circuit.

7. The valve of claim 1, further comprising at least one safety draining member configured to free a gas evacuation passage between the first end of the circuit and at least one evacuation orifice leading to the body if the draining member is subjected to a temperature and/or a pressure above a particular threshold.

8. The valve of claim 7, wherein:
the circuit further comprises a first isolation valve situated between, on the one hand, the two draw-off and filler branches, and on the other hand, the first end of the circuit; and
the circuit comprises a purge line having an upstream end connected in a portion of the circuit situated between the first isolation valve and the two draw-off and filler branches and a downstream end connected to the evacuation orifice or orifices of the draining member, the purge line comprising a second isolation valve.

9. The valve of claim 1, wherein the circuit includes a pressure sensor and/or a temperature sensor.

10. The pressurized gas storage facility comprising an orifice connected to a claim 1.

11. A station for filling pressurized gas tanks comprising at least one of the pressurized gas storage facility of claim 11 connected to at least one transfer line, the at least one transfer line intended to be connected to a pressurized gas tank to provide a transfer of gas from the storage facility to the tank for filling thereof, wherein the transfer line is connected to one of the draw-off ends of the body.

12. The filling station of claim 11, wherein one of the filler ends of the body is connected to a source of gas under pressure comprising a compressor and/or a gas and/or liquid tank.

13. A station for filling pressurized gas tanks comprising a plurality of pressurized gas storage facilities and a plurality of the valves of claim 1, each of the pressurized gas storage facilities comprising an orifice that is connected to a respective one of the plurality of valves of claim 1, the plurality of pressurized gas storage facilities being connected to at least one transfer line, the at least one transfer line intended to be connected to a pressurized gas tank to provide a transfer of gas from the storage facility to the tank for filling thereof, wherein the transfer line is connected in parallel to at least some of the draw-off ends of the storage facilities.

14. The filling station of claim 13, wherein at least some of the storage facilities are connected in parallel to a source of gas under pressure via their filler ends, the source of gas under pressure comprising a compressor and/or a gas and/or liquid tank.

15. A station for filling pressurized gas tanks comprising at least one pressurized gas storage facility and at least one of the valves of claim 7, each storage facility comprising an orifice connected to a respective one of the at least one valve of claim 7, wherein:
the circuit further comprises a first isolation valve situated between, on the one hand, the two draw-off and filler branches, and on the other hand, the first end of the circuit;
the circuit comprises a purge line having an upstream end connected in a portion of the circuit situated between the first isolation valve and the two draw-off and filler branches and a downstream end connected to the evacuation orifice or orifices of the draining member, the purge line comprising a second isolation valve;
each of the at least one valve of claim 7 includes two evacuation orifices leading to the body for evacuating the gas freed by the draining member; and
each of the at least one storage facility is connected in parallel to a gas evacuation line via its evacuation orifices.
